(19) United States
(12) Patent Application Publication
(10) Pub. No.: US 2015/0125276 A1
(43) Pub. Date: May 7, 2015

(54) BEARING HOLDING STRUCTURE

(71) Applicant: Asia Vital Components Co., Ltd., New Taipei City (TW)

(72) Inventors: Kuo-Chen Chang, New Taipei City (TW); Kuo-Chieh Chao, New Taipei City (TW)

(73) Assignee: Asia Vital Components Co., Ltd., New Taipei City (TW)

(21) Appl. No.: 14/069,757

(22) Filed: Nov. 1, 2013

(51) Int. Cl. F04D 25/06; F04D 19/00; H02K 5/167

(52) U.S. Cl. CPC F04D 25/062; H02K 5/1675; F04D 19/002
USPC 415/170.1; 310/425

(57) ABSTRACT

A bearing holding structure includes a base and at least one bearing. The base includes a bearing cup, which is axially extended from a center of the base and defines a receiving space therein. The bearing is fitted in the receiving space of the bearing cup and has a shaft hole. At least one groove is provided on one or both of an inner surface of the bearing cup and an outer surface of the bearing; and the groove is communicable with the receiving space of the bearing cup. The groove is filled with a meltable filler, which is melted by laser welding to fixedly connect the bearing and the bearing cup to one another, such that the bearing is not brought by a rotary shaft to rotate and slide in the bearing cup, enabling the bearing and the bearing cup to have prolonged service life.

### FIELD OF THE INVENTION

The present invention relates to a bearing holding structure, and more specifically, to a bearing holding structure for prolonging the bearing and bearing cup service life.

### BACKGROUND OF THE INVENTION

With the advancement in the technological field, electronic elements now have higher and higher operating performance. However, the high-performance electronic elements also produce more heat during operation thereof. So, highly effective heat dissipating units are required for heat dissipating.

Taking a computer as an example, the central processing unit (CPU) thereof produces a large amount of heat during operation. The CPU will have reduced operating efficiency when the temperature thereof continuously rises. When the accumulated heat is higher than an allowable limit, the computer will crash. In a worse condition, the CPU might become burned out. In addition, to solve the problem of electromagnetic radiation, the computer is usually enclosed in a case. Therefore, it is an important issue as how to timely remove the heat produced by the CPU and other heat generating elements from the case.

Furthermore, big-scale electronic apparatuses, such as workstations or servers, also generate a large amount of heat during operation. When these workstations or servers have a temperature higher than a preset working temperature, their performance will be adversely affected to even cause burnout and failure of electronic elements thereof. Since data or files stored in the workstations or servers are very important, any temporary crash or burnout of the workstations or the servers would cause great loss to users. Therefore, when setting up workstations or servers, special attention must be paid to good heat dissipation for the electronic elements to always operate within the allowable working temperature.

Hence, high-performance heat dissipating units have already become one of the foremost targets to be developed by the electronic industry. With the heat dissipating units, the heat produced by electronic elements can be timely removed. A heat dissipating unit usually includes a heat sink or a set of radiation fins and a correspondingly arranged cooling fan.

FIG. 1 is an exploded perspective view of a conventional bearing holding structure. As shown, a cooling fan 1 includes a base 11, a rotor assembly 12, and a stator assembly 13. The base 11 includes a bearing cup 111 and a bearing 112 disposed in the bearing cup 111. Due to a tolerance between the bearing 112 and an internal diameter of the bearing cup 111, the bearing 112 can be fitted in the bearing cup 111 without the risk of separating therefrom. The stator assembly 13 is mounted around the bearing cup 111. The rotor assembly 12 includes a hub 121, a plurality of blades 122, and a rotary shaft 123. The rotary shaft 123 is inserted in the bearing 112. When the cooling fan 1 operates, the rotary shaft 123 of the rotor assembly 12 rotates relative to the bearing 112. Since there is not any locating device provided between the bearing 112 and the bearing cup 111, the bearing 112 tends to rotate or slide in the bearing cup 111 when the rotary shaft 123 rotates relative to the bearing 112. After the cooling fan 1 has operated over a long period of time, the bearing 112 and the bearing cup 111 will wear to produce chips or powder, which eventually causes malfunction of the bearing 112 and unsmooth operation of the rotor assembly 12.

In sum up, the prior art bearing holding structure has the following disadvantages: (1) the bearing will be brought by the rotary shaft to rotate or slide in the bearing cup; and (2) the bearing and the bearing cup have shortened service life.

It is therefore tried by the inventor to develop an improved bearing holding structure for cooling fan.

### SUMMARY OF THE INVENTION

A primary object of the present invention is to provide a bearing holding structure that enables prolonged bearing and bearing cup service life.

Another object of the present invention is to provide a bearing holding structure that prevents a bearing from being brought by a rotary shaft to rotate or slide in a bearing cup.

To achieve the above and other objects, the bearing holding structure provided according to the present invention includes a base and at least one bearing. The base includes a bearing cup, which is extended from a center of the base and internally defines a receiving space. The bearing is fitted in the receiving space of the bearing cup and includes a shaft hole. At least one groove is provided on one or both of an inner surface of the bearing cup and an outer surface of the bearing; and the groove is communicable with the receiving space of the bearing cup.

The groove is filled with a meltable filler, which is melted by laser welding to fixedly connect the bearing to the bearing cup. With the foregoing arrangements, the bearing would not be brought by a rotary shaft to rotate or slide in the bearing cup. As a result, the bearing and the bearing cup can have prolonged service life.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional bearing holding structure for a fan;

FIG. 2A is an exploded perspective view of a bearing holding structure according to a first preferred embodiment of the present invention;

FIG. 2B is an assembled perspective view of the bearing holding structure according to the first preferred embodiment of the present invention;

FIG. 2C is a partially enlarged view of FIG. 2B;

FIG. 2D is an exploded perspective view showing the bearing holding structure according to the first preferred embodiment of the present invention and a rotor;

FIG. 3A is an exploded perspective view of a bearing holding structure according to a second preferred embodiment of the present invention;

FIG. 3B is an assembled perspective view of the bearing holding structure according to the second preferred embodiment of the present invention;

FIG. 3C is a partially enlarged view of FIG. 3B;

FIG. 4A is an exploded perspective view of a bearing holding structure according to a third preferred embodiment of the present invention;

FIG. 4B is an assembled perspective view of the bearing holding structure according to the third preferred embodiment of the present invention;

FIG. 4C is a partially enlarged view of FIG. 4B;

FIG. 4D is another partially enlarged view of FIG. 4B;

FIG. 5 is an assembled sectional view of a bearing holding structure according to a fourth preferred embodiment of the present invention;

FIG. 6A is an exploded perspective view of a bearing holding structure according to a fifth preferred embodiment of the present invention; and

FIG. 6B is an assembled perspective view of the bearing holding structure according to the fifth preferred embodiment of the present invention.

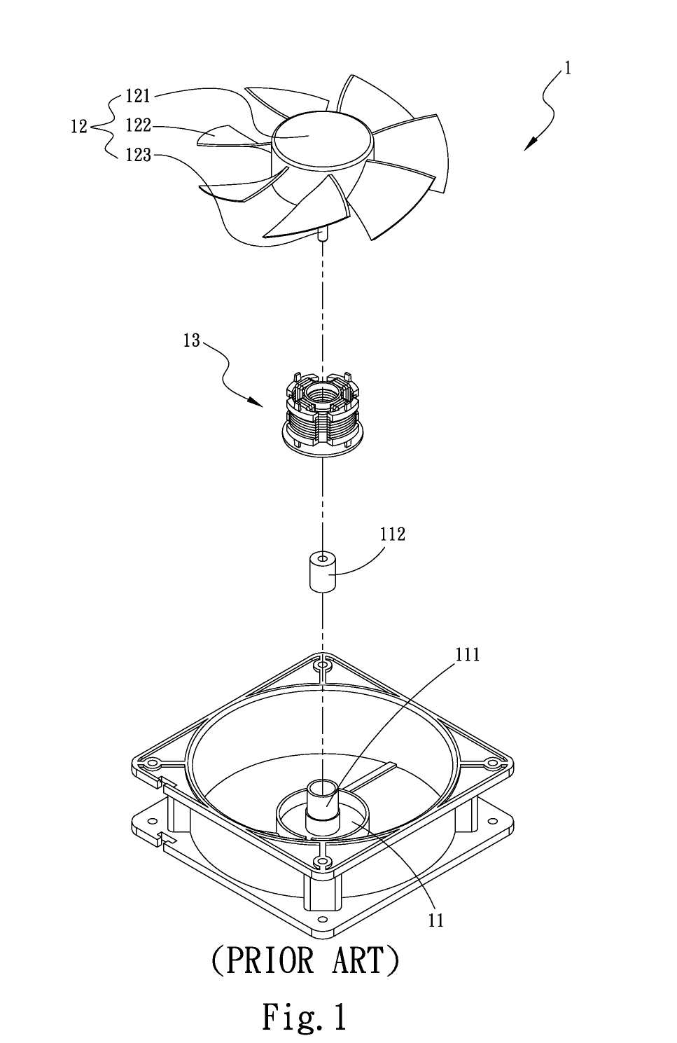

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

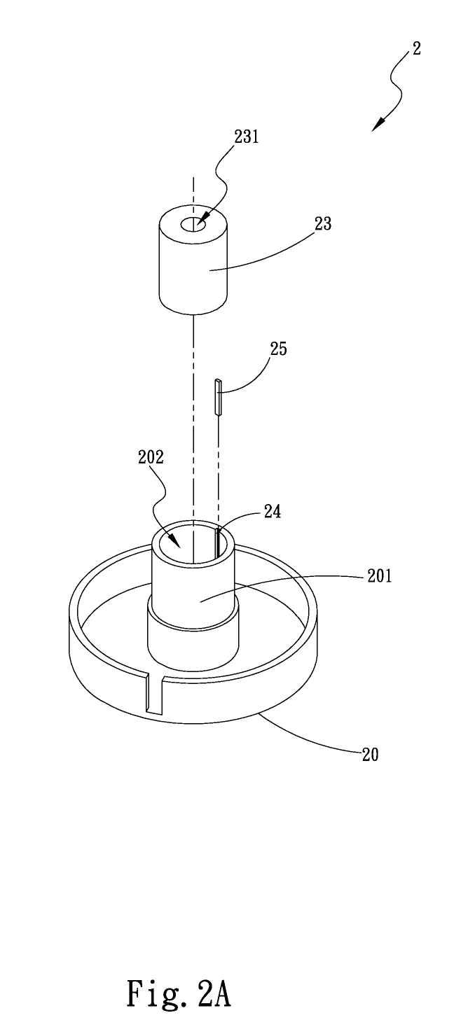

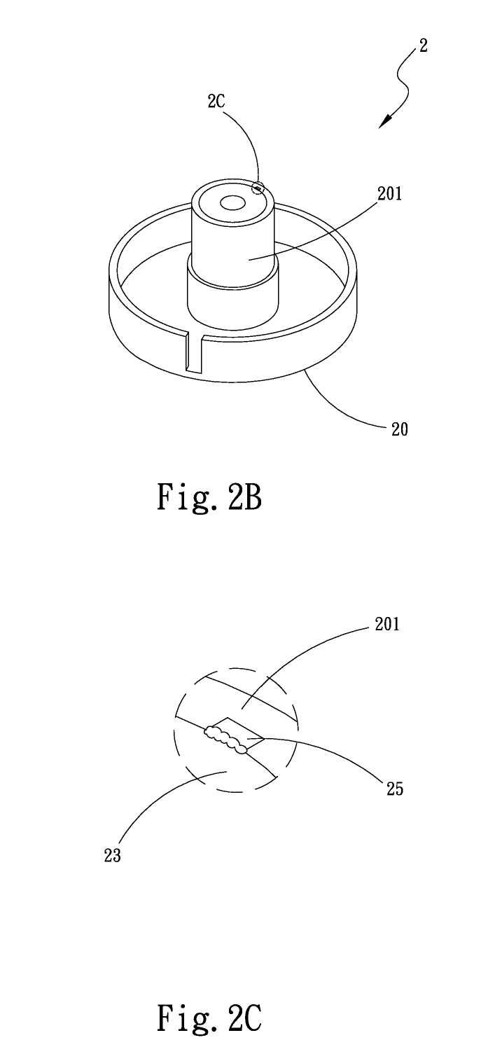

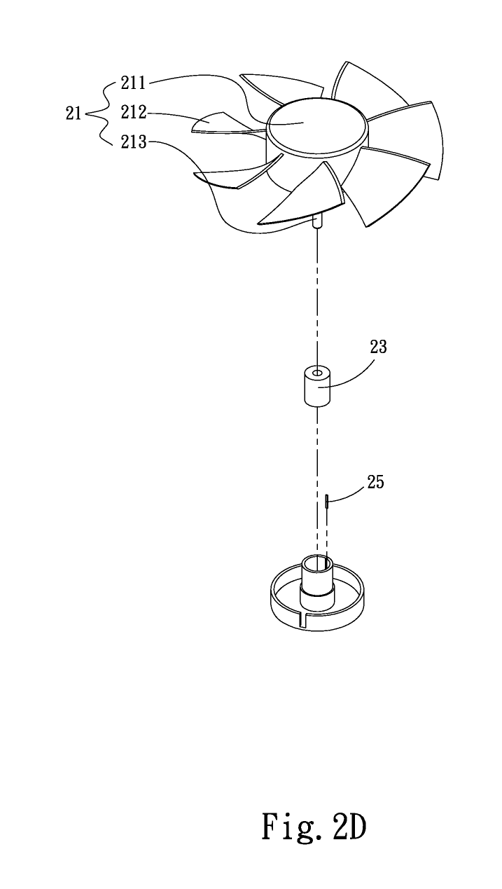

Please refer to FIG. 2A to FIG. 2D. FIG. 2A and FIG. 2B are exploded and assembled perspective views, respectively, of a bearing holding structure 2 according to a first preferred embodiment of the present invention. FIG. 2C is a partially enlarged view of FIG. 2B. FIG. 2D is similar to FIG. 2A but further illustrates a rotor. As shown, the bearing holding structure 2 includes a base 20, a rotor 21, at least one bearing 23, and at least one groove 24. The base 20 includes a bearing cup 201, which is axially extended from a center of the base 20 and defines a receiving space 202 therein. The rotor 21 includes a hub 211, a plurality of blades 212 circumferentially spaced on an outer surface of the hub 211, and a rotary shaft 213 extended from a center of the hub 211. The bearing 23 is fitted in the receiving space 202 and has a shaft hole 231. The rotary shaft 213 has an end fixedly connected to the center of the hub 211, and an opposite end extended through the shaft hole 231 of the bearing 23 into the receiving space 202. According to the present invention, the groove 24 can be provided on an inner surface of the bearing cup 201 or an outer surface of the bearing 24, or on both the inner surface of the bearing cup 201 and the outer surface of the bearing 23. And, the groove 24 is communicable with the receiving space 202.

In the first preferred embodiment, the groove 24 is axially provided on the inner surface of the bearing cup 201 for receiving a meltable filler 25, which can be melted by laser welding, such that the outer surface of the bearing 23 and inner surface of the bearing cup 201 are fixedly connected to one another at a position corresponding to the groove 24. With these arrangements, the bearing 23 is effectively prevented from being brought by the rotary shaft 213 to rotate or slide in the bearing cup 201, and therefore the bearing 23 and the bearing cup 201 can have prolonged service life.

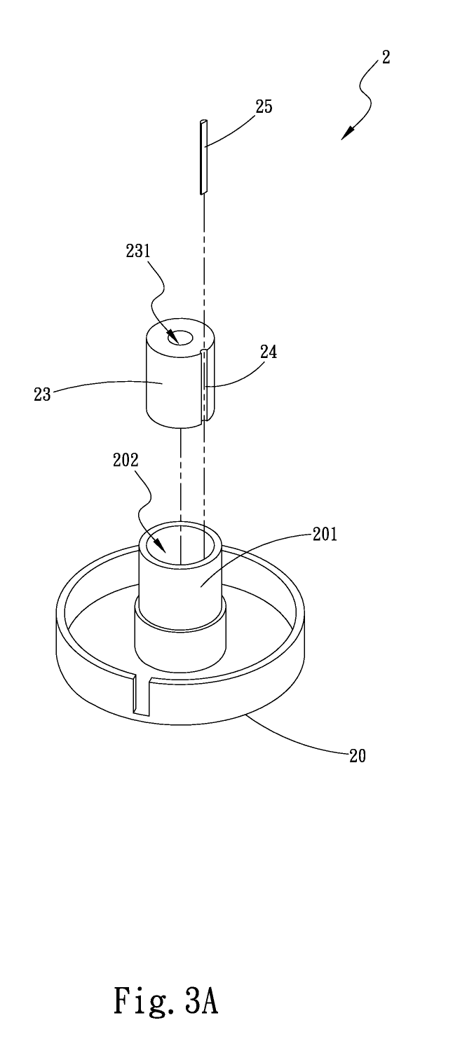

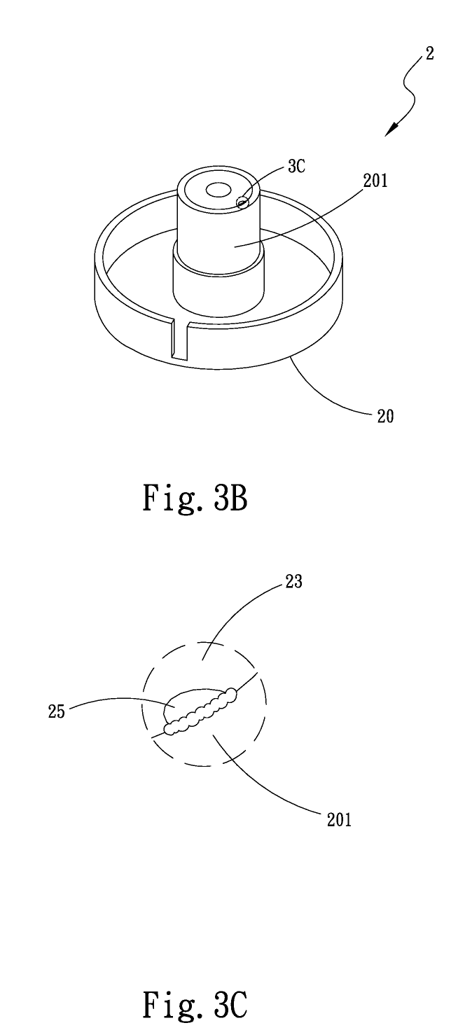

Please refer to FIG. 3A to FIG. 3C. FIG. 3A and FIG. 3B are exploded and assembled perspective views, respectively, of a bearing holding structure 2 according to a second preferred embodiment of the present invention. FIG. 3C is a partially enlarged view of FIG. 3B. The second preferred embodiment is generally structurally similar to the first preferred embodiment, except that, in the second embodiment, the groove 24 is axially provided on the outer surface of the bearing 23. Similarly, the groove 24 is filled with the meltable filler 25, which can be melted by laser welding, such that the outer surface of the bearing 23 and the inner surface of the bearing cup 201 are fixedly connected to one another at the position corresponding to the groove 24. With these arrangements, the bearing 23 is effectively prevented from being brought by the rotary shaft 213 to rotate or slide in the bearing cup 201, and therefore the bearing 23 and the bearing cup 201 can have prolonged service life.

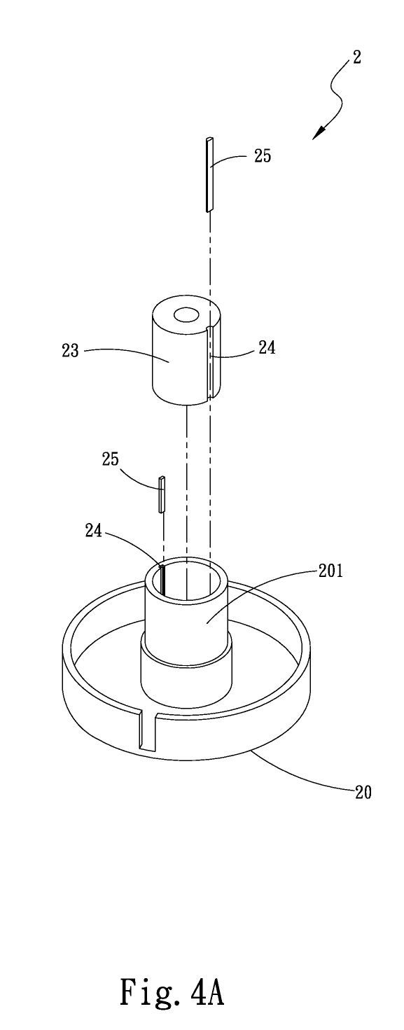

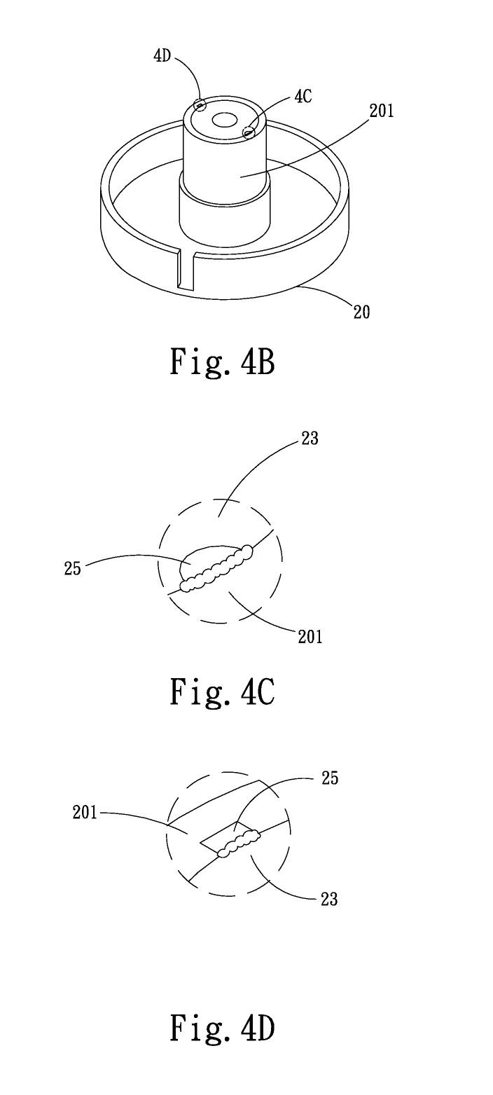

Please refer to FIG. 4A to FIG. 4C. FIG. 4A and FIG. 4B are exploded and assembled perspective views, respectively, of a bearing holding structure 2 according to a third preferred embodiment of the present invention. FIGS. 4C and 4D are two partially enlarged views of FIG. 4B. The third preferred embodiment is generally structurally similar to the first and the second preferred embodiment, except that, in the third preferred embodiment, both the inner surface of the bearing cup 201 and the outer surface of the bearing 23 are provided with at least one groove. Similarly, the grooves 24 provided on both the inner surface of the bearing cup 201 and the outer surface of the bearing 23 are filled with the meltable filler 25, which can be melted by laser welding, such that the outer surface of the bearing 23 and the inner surface of the bearing cup 201 are fixedly connected to one another at positions corresponding to the grooves 24. With these arrangements, the bearing 23 is effectively prevented from being brought by the rotary shaft 213 to rotate or slide in the bearing cup 201, and therefore the bearing 23 and the bearing cup 201 can have prolonged service life.

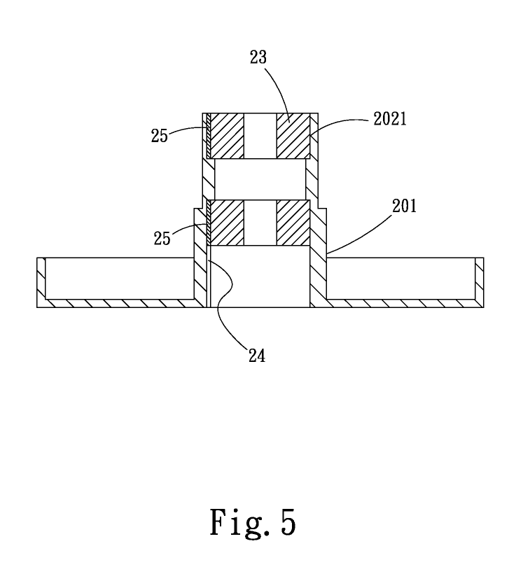

Please refer FIG. 5, which is an assembled sectional view of a bearing holding structure 2 according to a fourth preferred embodiment of the present invention. The fourth preferred embodiment is generally structurally similar to the previous preferred embodiments, except that, in the fourth preferred embodiment, at least a receiving section 2021 is formed on an inner surface of the bearing cup 201, and the bearing 23 is correspondingly fitted in the receiving section 2021.

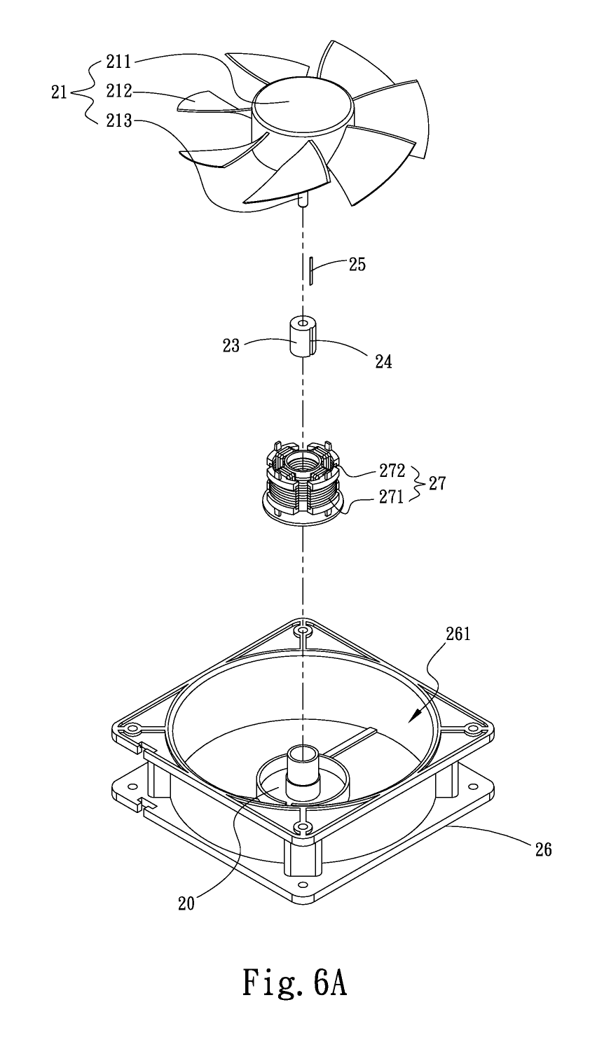

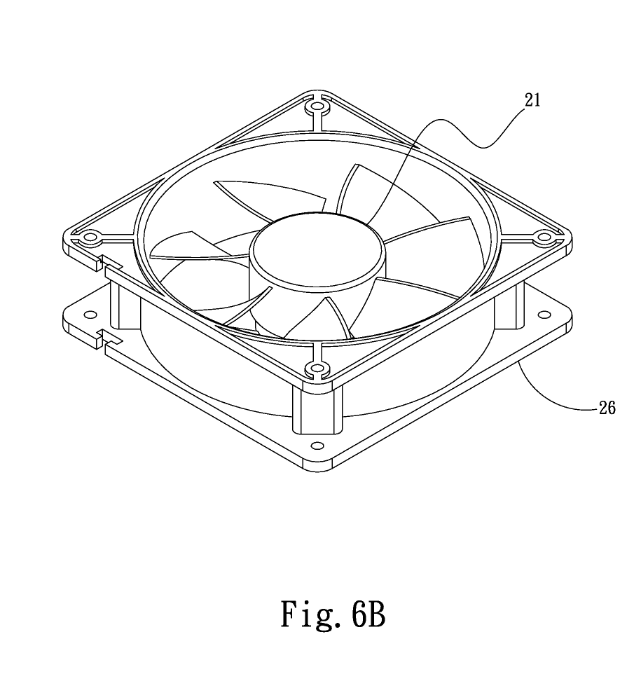

Please refer FIGS. 6A and 6B, which are exploded and assembled perspective views, respectively, of a bearing holding structure 2 according to a fifth preferred embodiment of the present invention. The fifth preferred embodiment is generally structurally similar to the previous preferred embodiments, but further includes a fan frame 26 and a stator 27. The base 20 is mounted to a center of the fan frame 26, and the fan frame 26 internally defines an accommodating space 261 for receiving the stator 27 therein. The stator 27 includes a plurality of silicon steel plates 271 and a plurality of coils 272 wound on the silicon steel plates 271.

In conclusion, the present invention is superior to the prior art bearing holding structure due to the following advantages: (1) prolonging the service life of the bearing and the bearing cup; and (2) preventing the bearing from being brought by the rotary shaft to rotate or slide in the bearing cup.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A bearing holding structure, comprising:
a base including a bearing cup, and the bearing cup being axially extended from a center of the base and defining a receiving space therein;
a rotor including a hub, a rotary shaft extended from a center of the hub, and a plurality of blades circumferentially spaced on an outer surface of the hub; and the rotary shaft having an end fixedly connected to the center of the hub;
at least one bearing being fitted in the receiving space of the bearing cup and including a shaft hole; and another opposite end of the rotary shaft being extended through the shaft hole into the receiving space of the bearing cup; and
at least one groove being selectively provided on one or both of an inner surface of the bearing cup and an outer surface of the bearing, and being communicable with the receiving space of the bearing cup.

2. The bearing holding structure as claimed in claim 1, wherein the bearing cup has at least one receiving section formed on the inner surface thereof, and the bearing being correspondingly fitted in the receiving section.

3. The bearing holding structure as claimed in claim 1, wherein the groove is filled with a meltable filler.

4. The bearing holding structure as claimed in claim 3, wherein the meltable filler is melted by laser welding to fixedly connect the bearing and the bearing cup to one another.

5. The bearing holding structure as claimed in claim 1, further comprising a fan frame, and the base being mounted to a center of the fan frame.

6. The bearing holding structure as claimed in claim 5, wherein the fan frame defines an accommodating space therein for accommodating a stator, and the stator including a plurality of silicon steel plates and a plurality of coils wound on the silicon steel plates.

7. The bearing holding structure as claimed in claim 1, wherein the groove is axially provided on the inner surface of the bearing cup, and the outer surface of the bearing is fixedly connected to the bearing cup at a position corresponding to the groove.

8. The bearing holding structure as claimed in claim 1, wherein the groove is axially provided on the outer surface of the bearing, and the inner surface of the bearing cup is fixedly connected to the bearing at a position corresponding to the groove.
